(19) United States
(12) Patent Application Publication
(10) Pub. No.: US 2019/0119049 A1
(43) Pub. Date: Apr. 25, 2019

(54) BAKERY TRAY STACKER

(71) Applicant: Rehrig Pacific Company, Los Angeles, CA (US)

(72) Inventors: Philip A. King, Sugar Hill, GA (US); William Robinson, Los Angeles, CA (US); Way Joe Lee, Marietta, GA (US); Dane Gin Mun Kalinowski, Foothill Ranch, CA (US)

(21) Appl. No.: 15/959,685

(22) Filed: Apr. 23, 2018

Related U.S. Application Data
(60) Provisional application No. 62/488,056, filed on Apr. 21, 2017.

(51) Int. Cl. B65G 57/30; B65G 59/06

(52) U.S. Cl. CPC B65G 57/303; B65G 2814/0308; B65G 2814/0304; B65G 59/063

(57) ABSTRACT

A stacker includes a base having a dolly-receiving area into which a dolly can be rolled. A vertical structure extends upward from the base. A pair of arms are pivotable toward and away from one another and toward and away from an area above the dolly-receiving area. The pair of arms are movable vertically relative to the vertical structure and are configured to engage containers supported on a dolly in the dolly-receiving area. In an alternate stacker, the pair of arms may be configured to revolve about an axis generally parallel to the arms and spaced away from the arms. In this manner the arms can dump the contents from a bin engaged by the arms.

### BACKGROUND

Stackable plastic trays are often used for shipping goods, such as bakery items. A common practice in the baking industry is to limit the stack height to 70-90″ for bakery trays leaving a bakery. However, for shipping efficiency, the trailer delivering the loaded bakery trays to the distribution center or retail location should ideally be cubed out to the internal height of the trailer, which may be 100-105″.

Large bins may be filled with product so that large numbers of the product may be shipped and stored efficiently. However, the filled bins may be too large and too heavy for a person to empty easily.

### SUMMARY

A stacker includes a base having a dolly-receiving area into which a dolly can be rolled. A vertical structure extends upward from the base. A pair of arms are pivotable toward and away from one another and toward and away from an area above the dolly-receiving area. The pair of arms are movable vertically relative to the vertical structure and are configured to engage containers supported on a dolly in the dolly-receiving area.

Each of the pair of pivoting arms may include a support tab having a raised inner portion configured to be positioned inward of an inner surface of a wall of a tray through which the support tab is inserted. Each raised inner portion may be an upturned inner edge of the support tab.

Each of the pair of pivoting arms may include a support tab configured to be inserted through a wall of a tray supported on a dolly in the dolly-receiving area. Each support tab may have an angled surface on an underside thereof, the angled surface configured to move the pivoting arm outward when the pivoting arm is moved downward into contact with a portion of a wall of the tray.

The stacker may includea dolly gripper mounted on the base for selectively securing a dolly in the dolly-receiving area. The dolly gripper may include a hook movably mounted to the base to be selectively positioned behind a portion of the dolly to secure the dolly in the dolly-receiving area. The stacker may include an electromagnet selectively securing the hook in a locked position in which the hook secures the dolly in the dolly-receiving area, so that deactivation of the electromagnet releases the dolly.

In an alternate embodiment, the pair of arms may be configured to revolve about an axis generally parallel to the arms and spaced away from the arms. In this manner the arms can dump the contents from a bin engaged by the arms.

Optionally, the stacker may include side walls extending upward from each of the pair of arms. At least one of the side walls may include an upper portion angling outward as it extends upward.

As an independent feature disclosed herein, the pair of arms may be part of a modular lifting unit, which is removable from the remainder of the stacker. The stacker could include a shuttle mounted to the vertical structure and movable vertically relative to the vertical structure, such that the modular lifting unit is removably mounted to the shuttle.

As another independent feature, the pair of arms may each include an inner portion having a height greater than an outer portion, such that the arms may interlock with openings in the container to be lifted by the arms.

### BRIEF DESCRIPTION OF THE DRAWINGS

FIG. 1 shows a stacker according to one embodiment and a stack of trays on a dolly being moved into the dolly-receiving area.

FIG. 2 is a side view, partially broken away, of the stacker of FIG. 1 and a dolly and tray being moved into the dolly-receiving area, with an enlarged area showing the dolly gripper of the stacker prior to engagement.

FIG. 3 is a view similar to FIG. 2 with the dolly and tray in the dolly-receiving area, with an enlarged area showing the dolly gripper of the stacker in engagement with the dolly.

FIG. 4 shows the stacker, dolly and trays of FIG. 1, with the dolly and trays in the dolly-receiving area and engaged by the arms of the stacker.

FIG. 5 shows the stacker, dolly and trays of FIG. 4, with the trays lifted above the dolly.

FIG. 6 shows the stacker, dolly and trays of FIG. 5, after the dolly is disengaged from the stacker.

FIG. 7 shows the stacker, dolly and trays of FIG. 5, with the trays being lowered toward the dolly.

FIG. 8 shows the stacker, dolly and trays of FIG. 7, with the trays supported on the dolly and the dolly disengaged from the stacker.

FIG. 9 is a top view of the dolly and one tray positioned in the stacker, with the arms, in the open position.

FIG. 10 is a perspective view of the stacker, dolly and tray of FIG. 9.

FIG. 11 is a top view of the dolly, tray and stacker of FIG. 10, with the arms, in the closed position.

FIG. 12 is a perspective view of the stacker, dolly and tray of FIG. 11.

FIG. 13 is a section view through the dolly, tray and one of the lifting arms, showing one of the support tabs received in one of the handle openings, prior to lifting by the lifting unit.

FIG. 14 is an interior perspective view of the handle opening and support tab of FIG. 13.

FIG. 15 is a section view through the dolly, tray and one of the lifting arms, showing one of the support tabs received in one of the handle openings, as the lifting unit is raising the lifting arm.

FIG. 16 is an interior perspective view of the handle opening and support tab of FIG. 15.

FIG. 17 is a section view of an alternate support tab in the handle opening of a tray, with the arm in the closed position.

FIG. 18 is an interior perspective view of the handle opening and support tab of FIG. 17.

FIG. 19 is a view similar to FIG. 17, with the arm being lowered relative to the tray.

FIG. 20 is an interior perspective view of the handle opening and support tab of FIG. 19.

FIG. 21 is a view similar to FIG. 19, with the arm being moved out of the handle opening of the tray.

FIG. 22 is an interior perspective view of the handle opening and support tab of FIG. 21.

FIG. 23 is a perspective view of an alternate stacker in which the lifting unit is modular and can easily be remove and replaced from a shuttle on the stacker.

FIG. 24 shows the stacker of FIG. 23, with the modular lifting unit separated from the shuttle on the stacker.

FIG. 25 shows the stacker of FIG. 23 with an alternate lifting unit.

FIG. 26 shows the alternate lifting unit of FIG. 25 removed from the stacker.

FIG. 27 shows an enlarged portion of the lifting unit.

FIG. 28 shows the shuttle secured to one of the vertical supports (the other removed for illustration).

FIG. 29 is a perspective view of an alternate stacker.

FIG. 30 shows a bin being lifted by the stacker of FIG. 29.

FIG. 31 shows the stacker of FIG. 29 in a first position.

FIG. 32 shows the stacker of FIG. 29 in a second position.

FIG. 33 is an enlarged view of a portion of the stacker of FIG. 29 in a third position.

FIG. 34 is a view similar to that of FIG. 33 with the stacker in a fourth position.

FIG. 35 is a view similar to that of FIG. 34 with the stacker in a fifth position, with the lifting unit substantially inverted.

FIG. 36 shows an alternate lifting unit.

FIG. 37 shows the lifting unit of FIG. 36 mounted to the stacker of FIG. 29 with a bin secured therein.

FIG. 38 is a rear view of the stacker, lifting unit and bin of FIG. 37.

FIG. 39 is a view similar to FIG. 38 without the stacker, for illustration.

FIGS. 40 and 41 show the lifting unit inverting the bin.

FIG. 42 shows an alternate lifting unit.

FIG. 43 shows the lifting unit of FIG. 42 engaging an alternate bin.

### DETAILED DESCRIPTION OF PREFERRED EMBODIMENTS

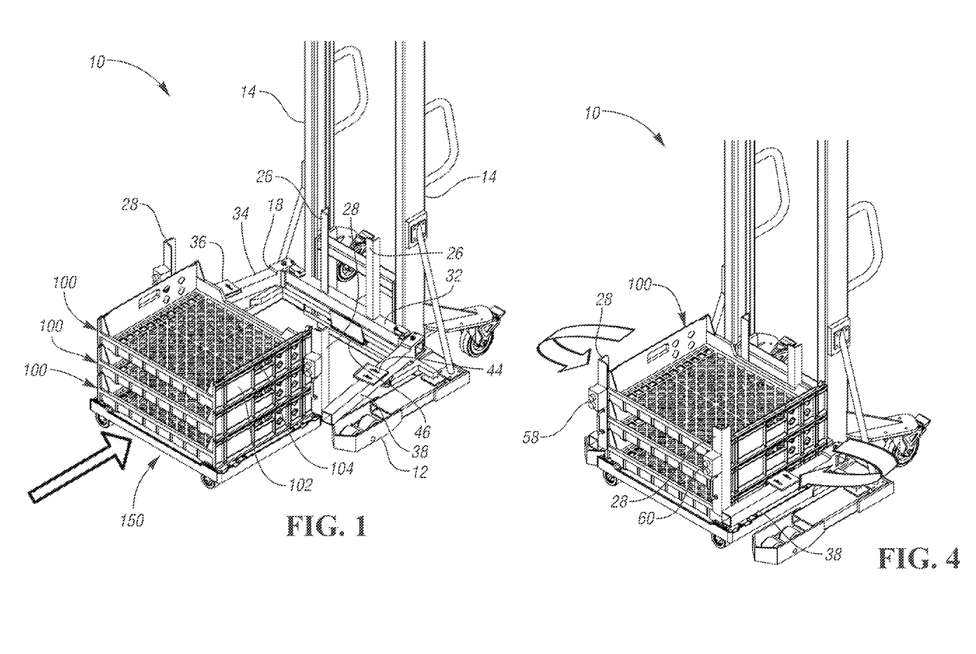

A stacker 10 according to one example embodiment is shown in FIG. 1. The stacker 10 includes a base including a pair of base supports 12 spaced apart to define a dolly-receiving area, and a vertical structure extending upward from the base, wherein the vertical structure includes a pair of parallel vertical supports 14. A lifting unit 18 is slidably supported on the vertical supports 14 and is slidable vertically relative to the vertical supports 14.

An upper bracket connects upper ends of the vertical supports 14. A cable is connected to the lifting unit 18 and to a lifting mechanism, such as a winch or other motor to selectively lift and lower the lifting unit 18 relative to the vertical supports 14.

The lifting unit 18 includes a pair of rear tip guards 26 extending upward from a rearward portion of the lifting unit 18. A pair of front tip guards 28 extend upward at a frontward portion of the lifting unit 18.

The lifting unit 18 includes a rear portion 32 (such as a metal bar or beam). A first arm 34 extends forwardly and transversely from a first side of the rear portion 32 and is pivotably mounted to the rear portion 32. A first support tab 36 or first projection projects inward from the first arm 34.

A second arm 38 is pivotably secured to a second side of the rear portion 32. A second support tab 44 or second projection projects inward from the second arm 38. The second support tab 44 and the first support tab 36 project toward one another. The support tabs 36, 44 are adjustable on the arms 34, 38 to accommodate different size trays 100. The front tip guards 28, which may be L-shaped cross-section brackets, are mounted at a forward ends of the first arm 34 and second arm 38. The width of the lift unit 18 may also be adjustable (e.g. by adjusting a length of the rear portion 32). The rear tip guards 26 project upward from the rear portion 32. A dolly gripper 46 is mounted to the base 12 proximate the rear portion 32 of the lifting unit 18.

The lifting unit 18 can lift a plurality of trays 100 from a stack of trays 100 stacked on a dolly 150. Each of the plurality of trays 100 includes a pair of opposed side walls 102 having handle openings 104 therethrough. FIG. 1 shows the dolly 150 and stack of trays 100 partially received in the stacker 10 and not yet secured to the stacker 10.

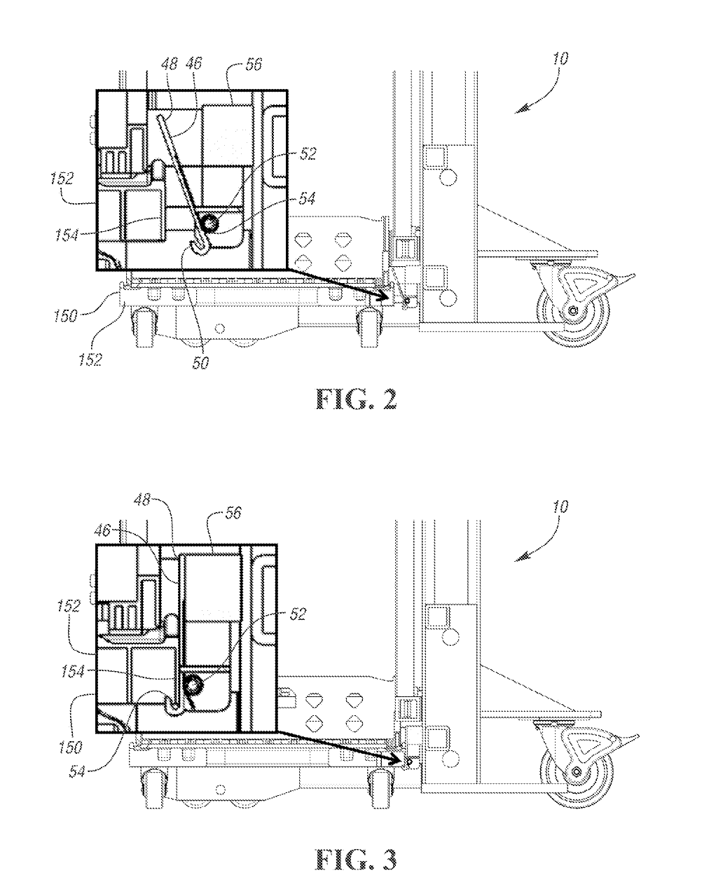

FIG. 2 shows the dolly 150 and only one tray 100 for illustration, with an enlarged view portion. The dolly 150 includes a deck 152 supported by wheels or casters. The deck 152 includes a front rib 154 extending downward to a free end. The front rib 154 is positioned proximate the dolly gripper 46. The dolly gripper 46 includes an upper contact portion 48, which may be generally planar, and a lower hook portion 50, which is curved forwardly and upwardly from a bottom edge of the upper contact portion 48. The dolly gripper 46 is pivotably mounted on a pin 52 and rotationally biased to the position shown by a spring 54, which may be mounted on the pin 52. An electromagnet 56 is mounted behind the upper contact portion 48 of the dolly gripper 46 and spaced away from the upper contact portion 48 in FIG. 2, which is an unlocked position.

As the dolly 150 is moved further into the stacker 10, the dolly 150 contacts the upper contact portion 48 of the dolly gripper 46, pivoting the dolly gripper 46 into contact with the electromagnet 56, which is activated and retains the dolly gripper in the locked position as shown in FIG. 3. As the dolly gripper 46 pivots, the hook portion 54 moves upward behind the front rib 154 of the deck 152 of the dolly 150, thereby hooking the front rib 154 (and the dolly 150) to the stacker 10. The electromagnet 56, while activated, holds the dolly gripper 46 in the locked position, thereby retaining the dolly 150 in position in the stacker 10.

As shown in FIG. 4, the arms 34, 38 are then pivoted to the closed position, with the front tip guards 28 positioned in front of the front edges of the trays 100 and the support tabs 36, 44 received in the handle openings 104 in one of the trays 100 (such as the lowermost tray 100, or whichever tray 100 is intended to be lifted). Upper surfaces of the first support tab 36 and the second support tab 44 provide support surfaces for engaging the tray 100. Pivoting the arms 34, 38 closed activates microswitches (not shown), which activate the electromagnet 56 (FIG. 3) to retain the dolly 150 and trays 100 in the stacker 10. The rear tip guards 26 and the front tip guard 28 hold the tray 100 in place.

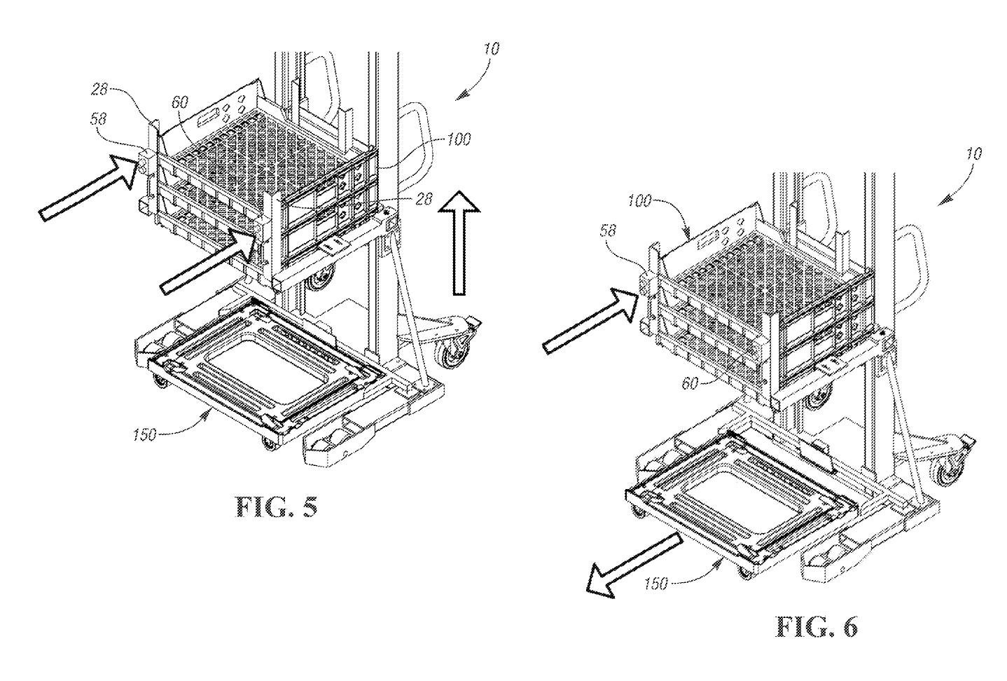

Referring to FIG. 5, a pair of buttons 58 (any user-activated switch) are mounted on the first tip guard 28 and a pair of buttons 60 are mounted to the second tip guard 28. Pressing the two upper buttons 58, 60 simultaneously causes the stacker 10 to lift the lifting unit 18 upward, thereby lifting the trays 100 from the dolly 150.

Referring to FIG. 6, pressing one of the lower buttons (e.g. lower button 58) by passes the micro switches and deactivates the electromagnet 56 (FIG. 3) to release the dolly 150 from the stacker 10.

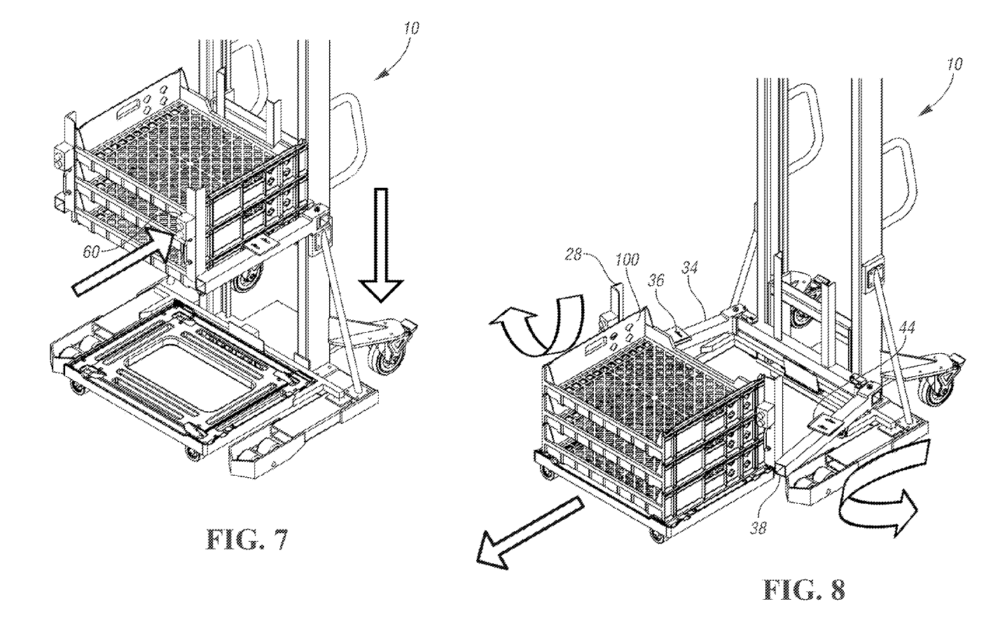

Referring to FIG. 7, pressing the other of the lower buttons (e.g. lower button 60) causes the stacker 10 to lower the lifting unit 18, thereby lowering the trays 100 toward the dolly 150.

Referring to FIG. 8, after the trays 100 are lowered onto the dolly 150, the arms 34, 38 are pivoted outward, which moves the front tip guards 28 and support tabs 36, 44 out of the way, and also deactivates the micro switches, which deactivates the electromagnet 56 (FIG. 3) to release the dolly 150 from the stacker 10.

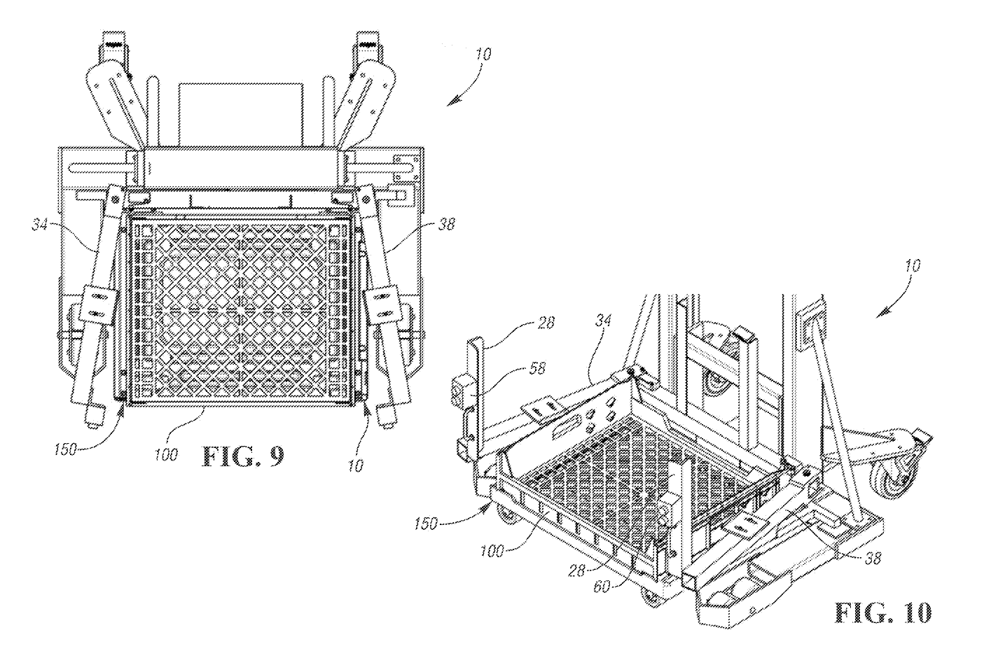

FIGS. 9 and 10 show the stacker 10 with a dolly 150 and one tray 100 positioned in the stacker 10, with the arms 34, 38 in the open position.

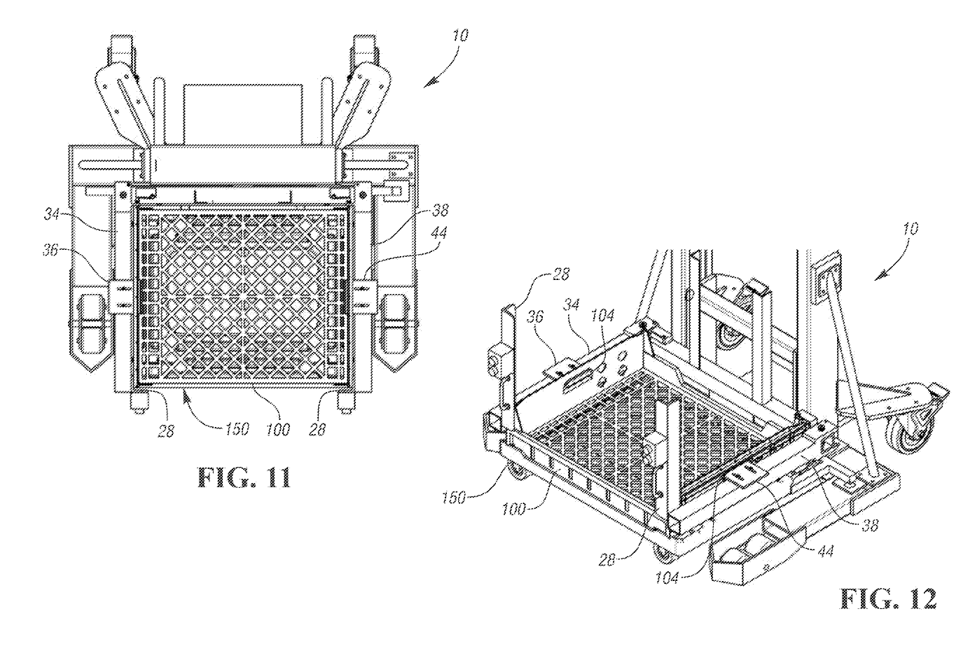

FIGS. 11 and 12 show the stacker 10 with the dolly 150 and tray 100 of FIGS. 9 and 10, but with the arms 34, 38 in the closed position. The support tabs 36, 44 are received in the handle openings 104 of the tray 100. The front tip guards 28 are positioned in front of the tray 100 to retain the tray 100 in the stacker 10.

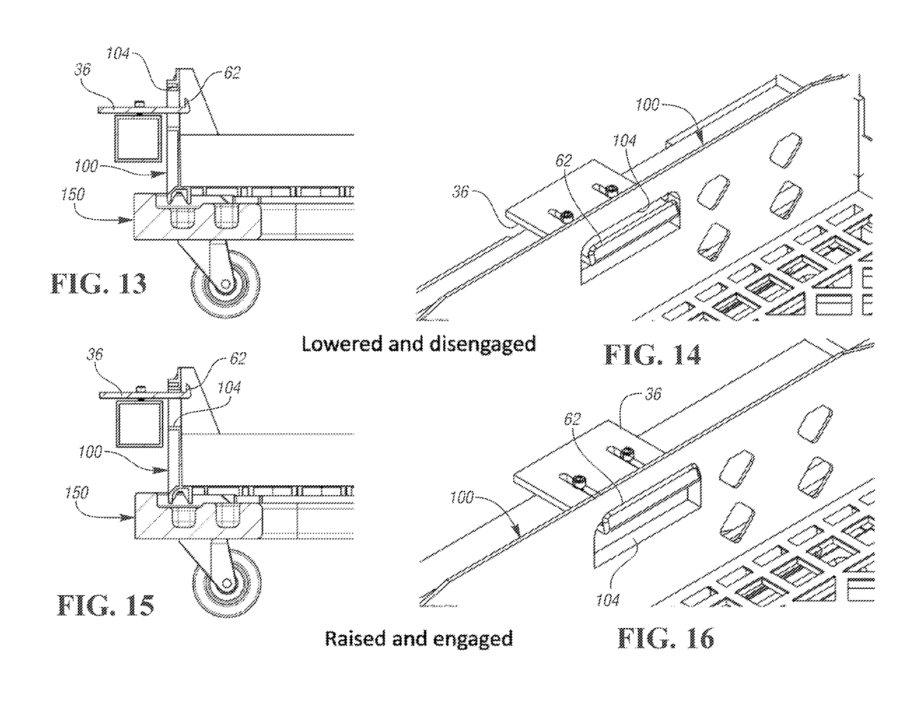

FIGS. 13 and 14 show one of the support tabs 36 received in one of the handle openings 104, prior to lifting by the lifting unit 18. As shown, the support tab 36 includes a raised inner portion 62, such as an upturned edge, that is inserted through the handle opening 104. A shown in FIGS. 15 and 16, as the lifting unit 18 is raised, the tab 36 engages the wall of the tray 100 and the raised inner portion 62 assists in retaining the engagement of the tab 36 with the wall of the tray 100. The support tab 44 on the other arm 38 would be the same.

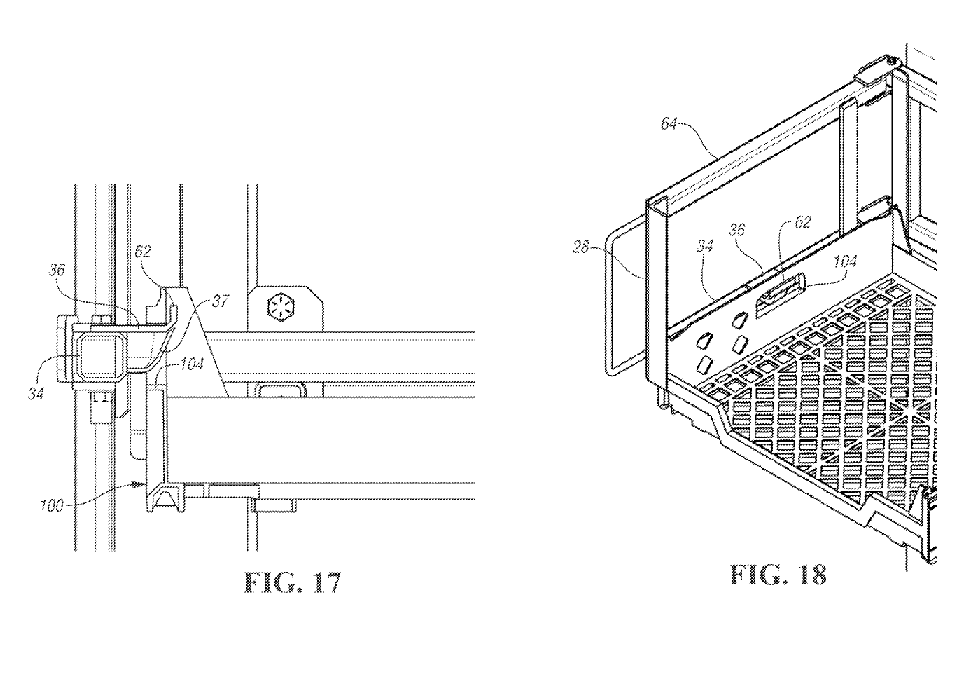

FIGS. 17 and 18 show an optional feature that could be included in the stacker 10 of FIGS. 1-16. A ramp 37 below the support tab 36 extends at an angle away from the outer edge of the support tab 36. In FIGS. 17 and 18, the arm 34 is shown in the closed position. FIG. 18 also illustrates another optional feature, a pair of upper support members 64 (one shown) providing lateral support to a stack of trays and reinforcing the front tip guards 28. The upper support members 64 are spaced above and generally parallel to the arms 34.

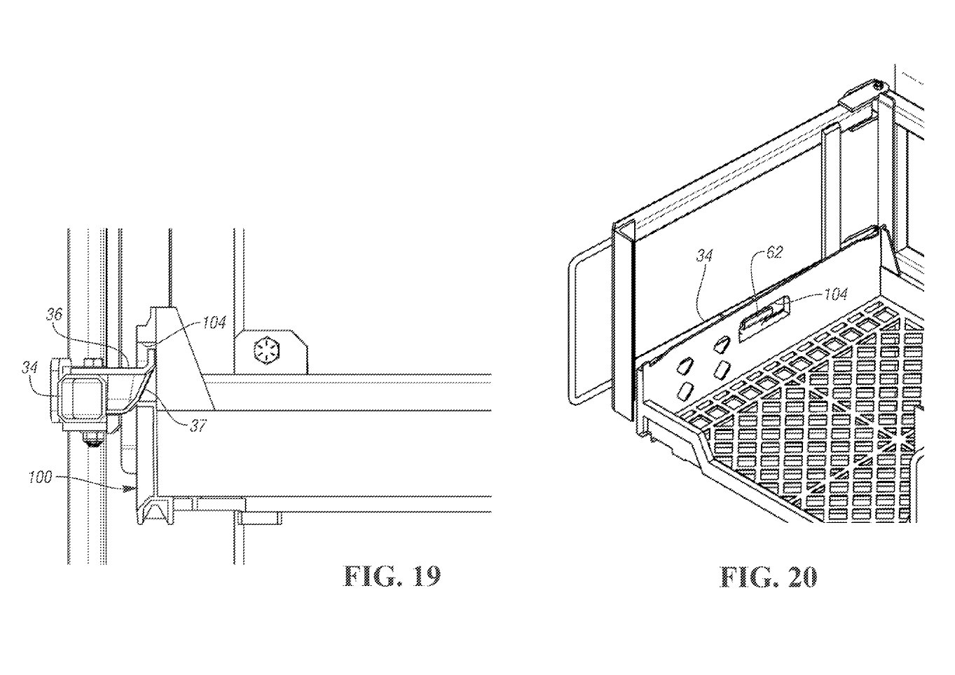

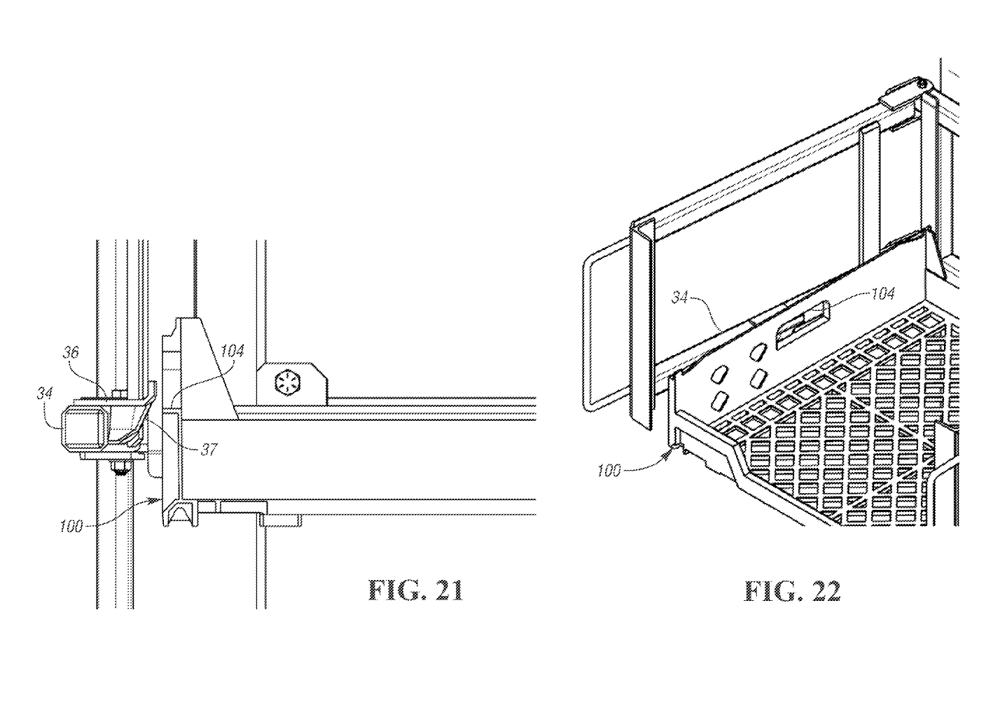

FIGS. 19 and 20 show the arm 34 being lowered relative to the tray 100. The angled surface of the ramp 37 hits the wall of the tray 100 in the handle opening 104. This causes the arm 34 to move outward, moving the support tab 36 out of the handle opening 104, as shown in FIGS. 21 and 22.

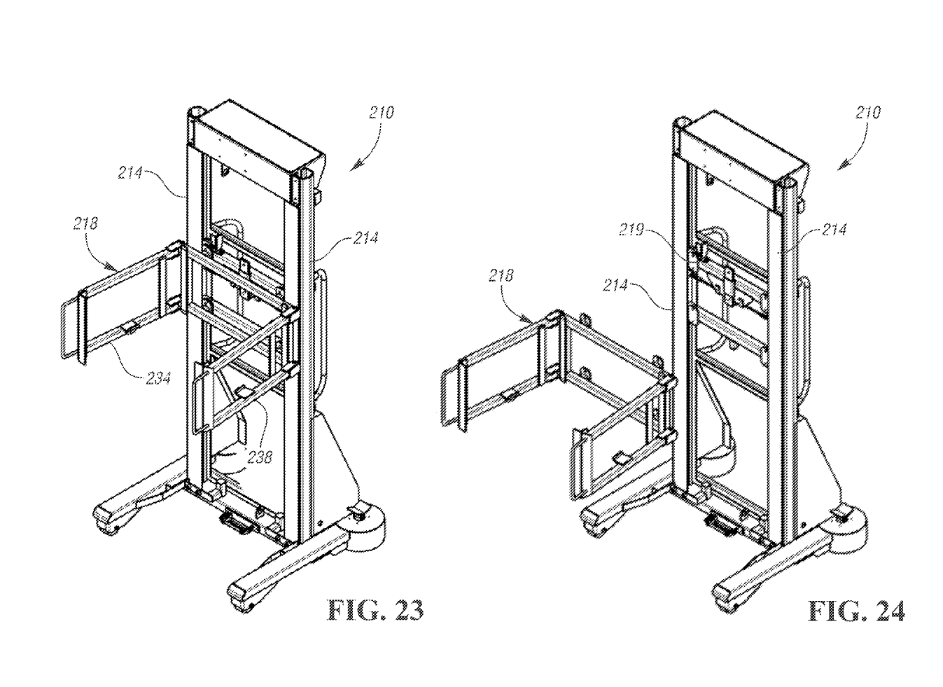

FIGS. 23 and 24 illustrate another optional feature that could be included in the stacker 10 of FIGS. 1-22. The lifting unit 218 is modular and can be easily removed and replaced on the stacker 210. The lifting unit 218 is selectively secured to a shuttle 219 that moves upward and downward relative to the vertical portions 214 of the stacker 210.

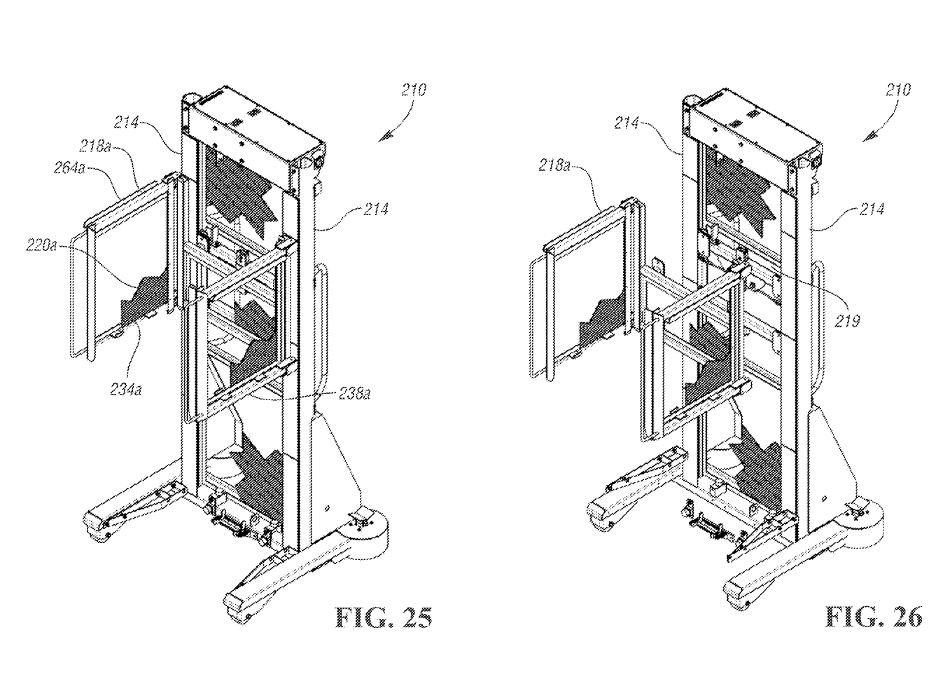

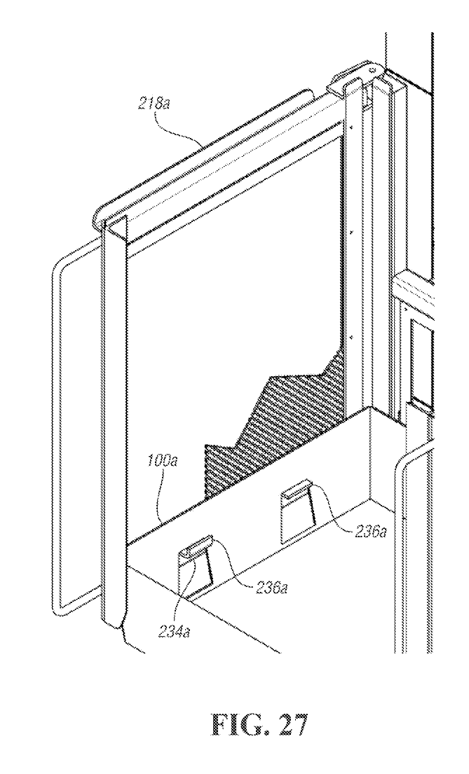

FIG. 25 shows the stacker 210 with an alternate lifting unit 218a having a pair of arms 234a, 238a upper support members 264a and optional panels 220a covering the area between each arm 234a, 238a and the associated upper support member 264a. As shown in FIG. 26, the lifting unit 218a is easily removable and reattachable to the shuttle 219 on the stacker 210 (via screws, bolts, etc). FIG. 27 shows an enlarged portion of the lifting unit 218a. As shown, the arm 234a has a pair of spaced apart support tabs 236a. The lifting units 218, 218a, etc, can be selectively secured to the stacker 210 to match the type of tray 100, 100a being lifted.

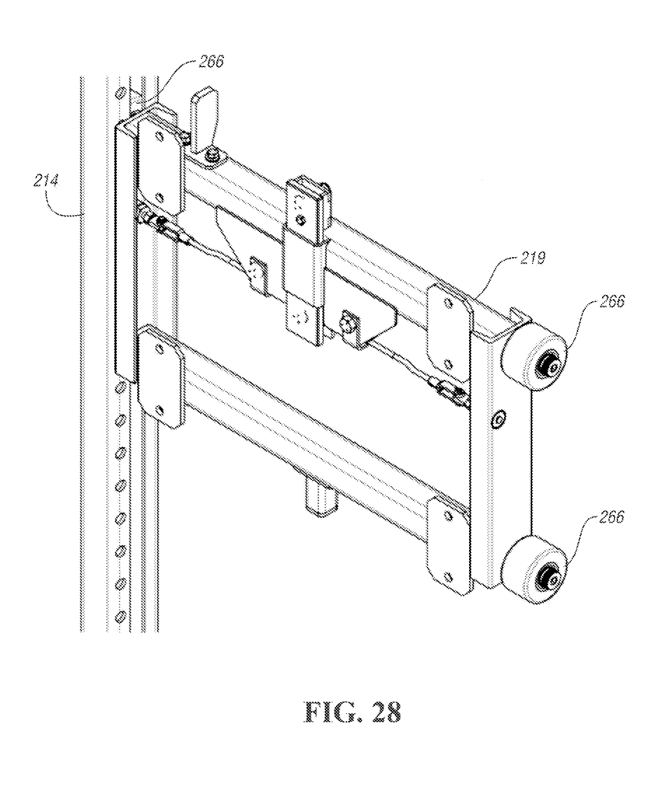

FIG. 28 shows the shuttle 219 secured to one of the vertical supports 214 (the other removed for illustration). The shuttle 219 includes a plurality of rollers 266 captured in a track within each vertical support 214. The shuttle 219 also includes a braking system, such as is described more fully in co-pending application U.S. Ser. No. 15/411,195, filed Jan. 20, 2017, which is hereby incorporated by reference in its entirety.

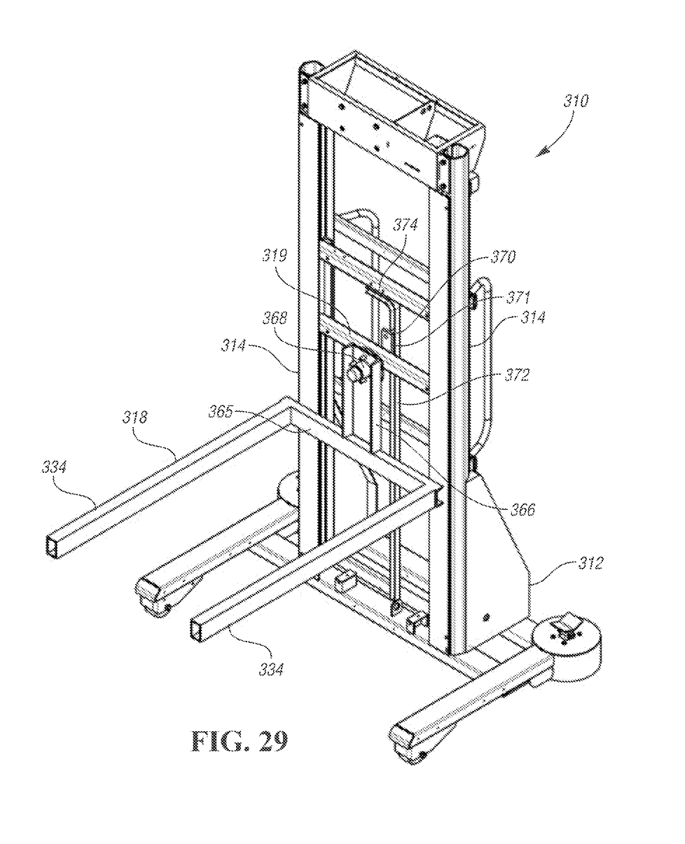

FIG. 29 is a perspective view of an alternate stacker 310 including a base 312 and a pair of vertical structures 314 extending upward from the base. A shuttle 319 is movable vertically relative to the vertical structures 314 by a lifting mechanism, such as an electric motor, either at the top of the stacker 310, or in the base 312 with one or more pulleys at the top of the stacker 310. A lifting unit 318 is secured to the shuttle 319 by a pivot pin 368 pivotably securing one end of a bracket 366 of the lifting unit 318 to the shuttle 319. The other end of the bracket 366 is secured to a cross beam 365, from ends of which the arms 334 of the lifting unit 318 extend forwardly. The pivot pin 368 is non-rotationally fixed to the bracket 366 and rotatable relative to the shuttle 319. The pivot pin 368 is also non-rotationally fixed to a lever 371 having a small roller 370 extending rearwardly therefrom. The roller 370 is captured in a track having a long vertical portion 372 curving into a short horizontal portion 374.

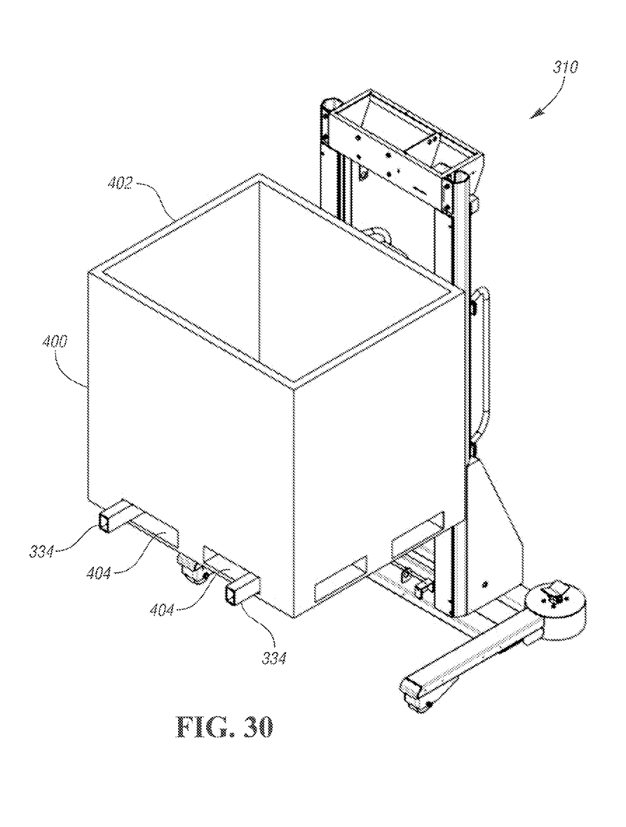

As shown in FIG. 30, the arms 334 can be received in the fork tine openings 404 of a bin 400 having side walls 402. The stacker 310 can be used to lift the bin 400 (e.g. from a dolly or from the floor) and dump the contents, as will be explained below.

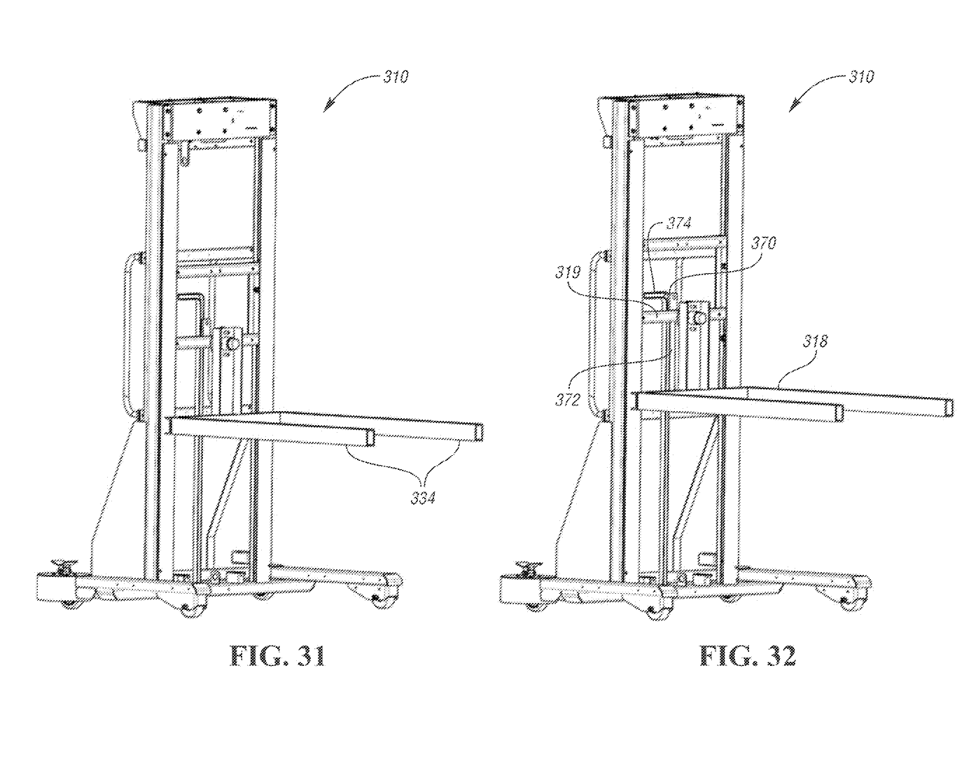

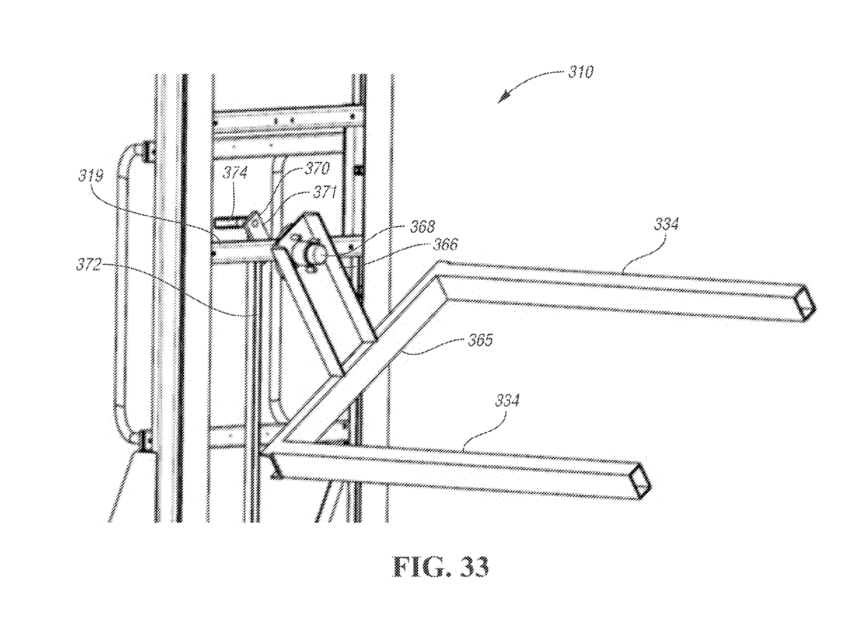

As shown in FIGS. 31 and 32, the shuttle 319 first lifts the lifting unit 318 and arms 334 vertically. Referring to FIG. 33, the roller 370 follows the vertical portion 372 of the track until it enters the curve toward the horizontal portion 374 of the track. This rotates the lever 371 and pivot pin 368, which causes bracket 366 and cross beam 364 to rotate. This causes the arms 334 to revolve about an axis generally parallel to the arms 334 (generally through the pivot pin 368), as the arms 334 and the axis (pivot pin 368) also translate upward.

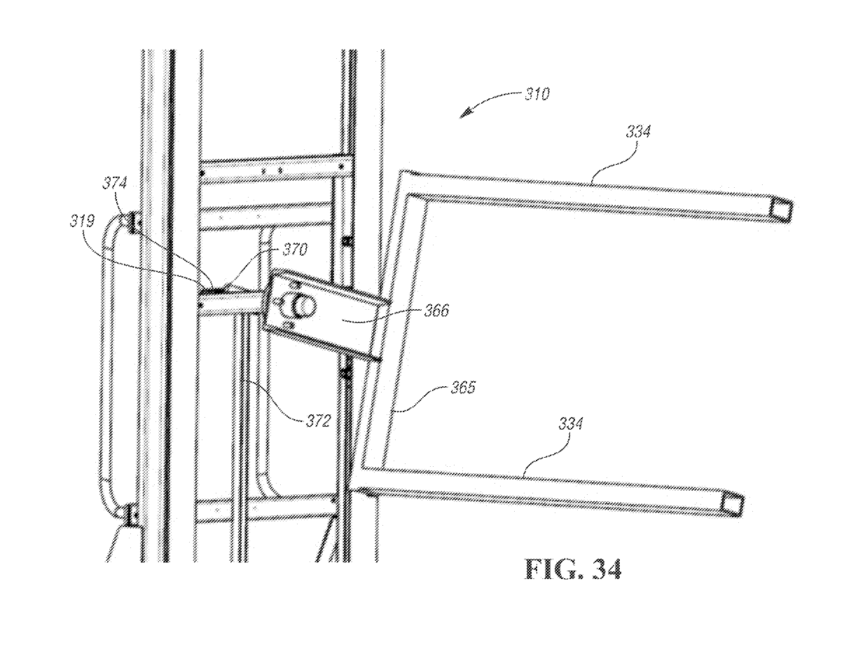

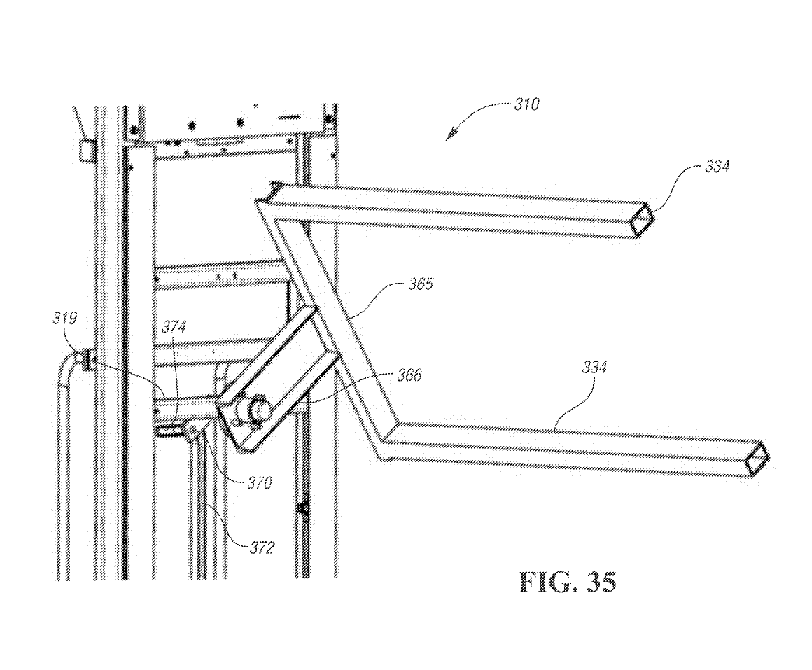

As shown in FIGS. 34 and 35, as the shuttle 319 and pivot pin 368 continues to rise, they eventually rise above the horizontal portion 374 of the track. This causes the roller 370 to return toward the curve of the track and causes the lifting unit to substantially invert, as shown in FIG. 35. In this manner, the bin 400 (FIG. 30) could be lifted and dumped by the stacker 310.

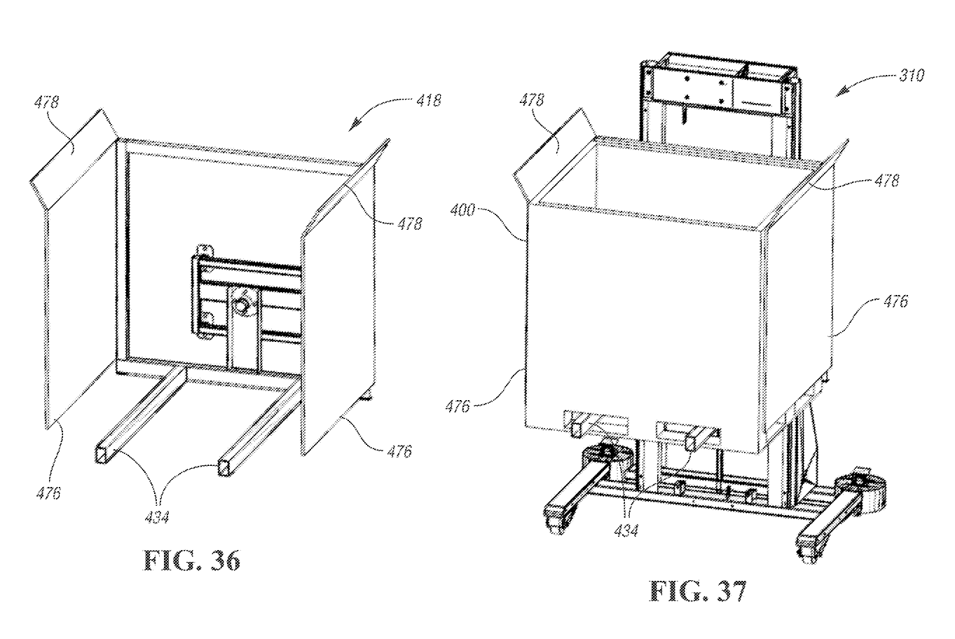

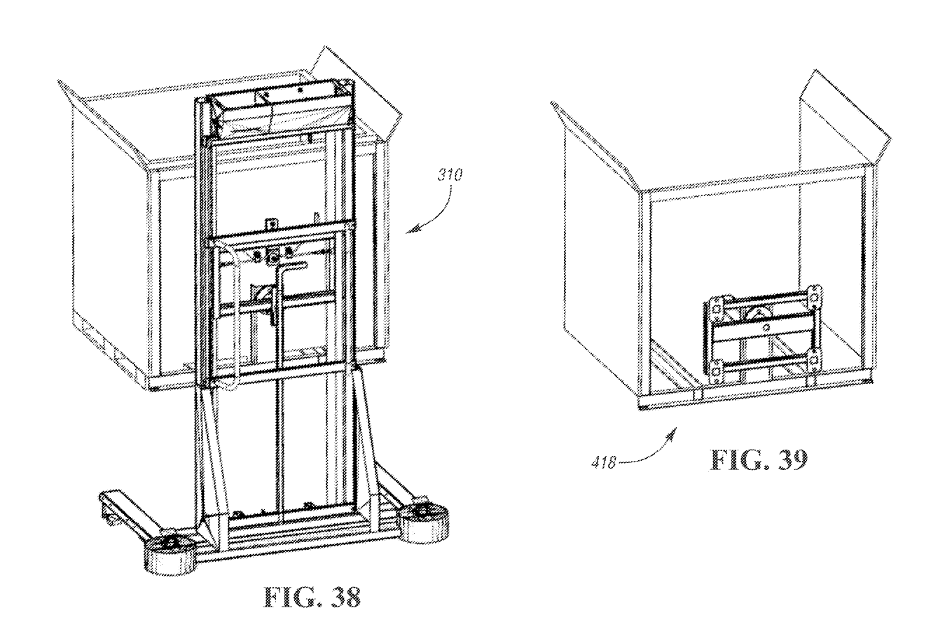

FIG. 36 shows an alternate lifting unit 418, with arms 434 and side walls 476 spaced outward of the arms 434. Angled upper portions 478 of the side walls 476 extend outward as they extend upward to facilitate emptying the contents of a bin lifted and dumped by the lifting unit 418. FIG. 37 shows the lifting unit of FIG. 36 mounted to the stacker 310 with a bin 400 secured therein between the side walls 476. FIG. 38 is a rear view of the stacker 310, lifting unit 418 and bin 400. FIG. 39 is a view similar to FIG. 38 without the stacker 310.

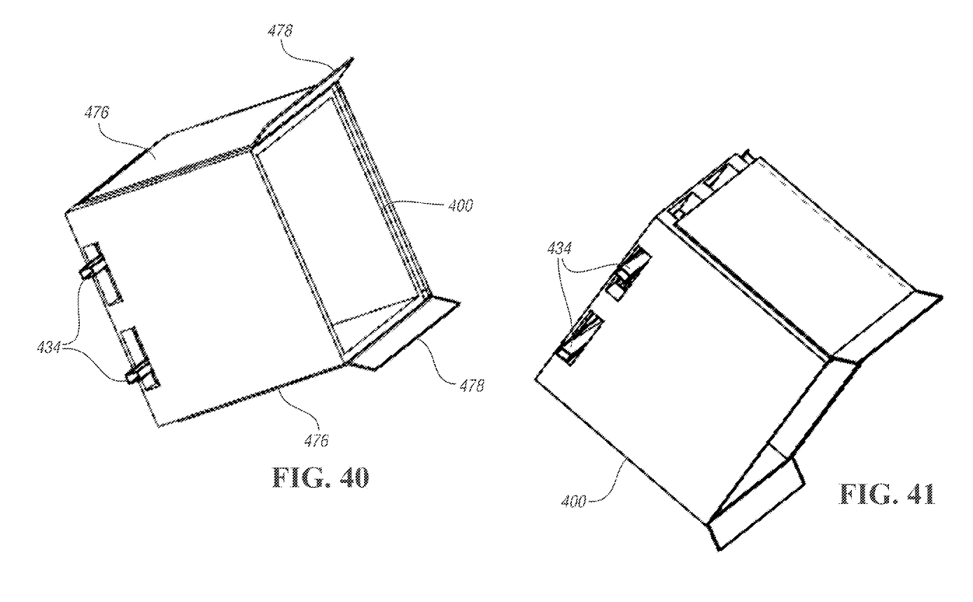

As shown in FIGS. 40 and 41, using the stacker 310 (not shown) the lifting unit 418 can lift and rotate the bin 400 to empty the contents of the bin 400.

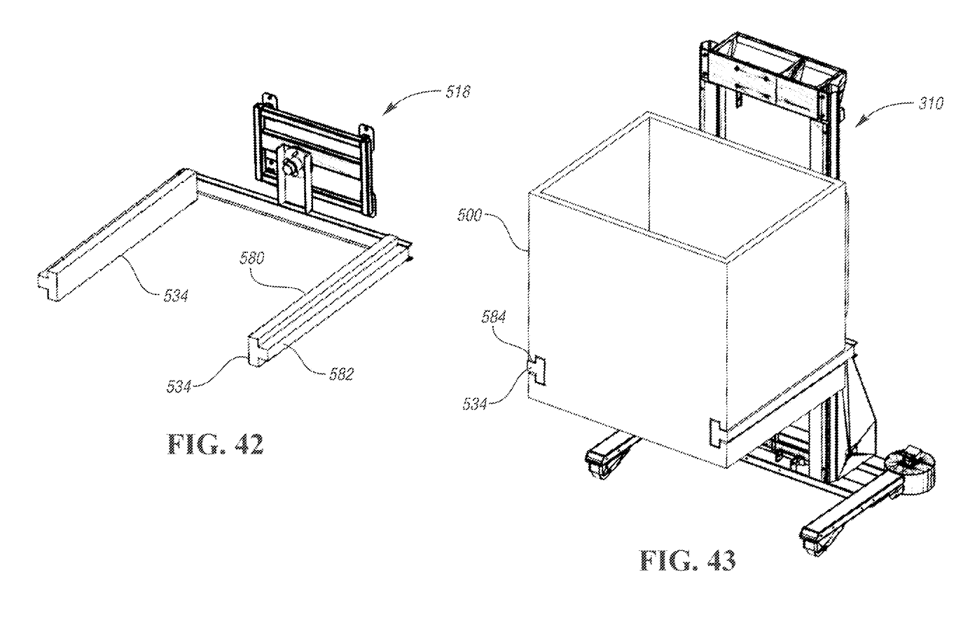

FIG. 42 shows an alternate lifting unit 518 with alternate arms 534. Each arm 534 has an inner portion with a height greater than an outer portion 582. In this manner, as shown in FIG. 43, the arms 534 can interlock with complementary openings in the base of a bin 500 so that the bin 500 can be lifted an inverted by the stacker securely.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A stacker comprising:
a base having a dolly-receiving area into which a dolly can be rolled;
a vertical structure supported on the base; and
a pair of arms pivotable toward and away from one another and toward and away from an area above the dolly-receiving area, the pair of arms movable vertically relative to the vertical structure and configured to engage containers supported on a dolly in the dolly-receiving area.

2. The stacker of claim 1 wherein each of the pair of pivoting arms includes a support tab having a raised inner portion configured to be positioned inward of an inner surface of a wall of a tray through which the support tab is inserted.

3. The stacker of claim 2 wherein each raised inner portion is an upturned inner edge of the support tab.

4. The stacker of claim 1 wherein each of the pair of pivoting arms includes a support tab configured to be inserted through a wall of a tray supported on a dolly in the dolly-receiving area, each support tab having an angled surface on an underside thereof, the angled surface configured to move the pivoting arm outward when the pivoting arm is moved downward into contact with a portion of a wall of the tray.

5. The stacker of claim 1 wherein the pair of arms are configured to revolve about an axis generally parallel to the arms and spaced away from the arms.

6. The stacker of claim 5 wherein the pair of arms are each pivotable about axes generally parallel to the vertical structure.

7. The stacker of claim 5 further including an upper support above each of the pair of arms.

8. The stacker of claim 7 wherein the upper support is spaced above each of the pair of arms.

9. The stacker of claim 7 further including a front tip guard extending upward from each of the pair of arms and wherein each upper support is secured to one of the front tip guards.

10. The stacker of claim 1 further including side walls extending upward from each of the pair of arms.

11. The stacker of claim 10 wherein the pair of arms are configured to revolve about an axis generally parallel to the arms and spaced away from the arms.

12. The stacker of claim 11 wherein at least one of the side walls includes an upper portion angling outward as it extends upward.

13. The stacker of claim 1 wherein the pair of arms are part of a lifting unit, which is removable from the remainder of the stacker.

14. The stacker of claim 12 wherein the stacker includes a shuttle mounted to the vertical structure and movable vertically relative to the vertical structure, wherein the lifting unit is removably mounted to the shuttle.

15. The stacker of claim 1 wherein the pair of arms each include inner faces facing one another, and wherein each of the pair of arms includes an inner portion having a height greater than an outer portion.

16. The stacker of claim 1 further including a dolly gripper mounted on the base for selectively securing a dolly in the dolly-receiving area.

17. The stacker of claim 16 wherein the dolly gripper includes a hook movably mounted to the base to be selectively positioned behind a portion of the dolly to secure the dolly in the dolly-receiving area.

18. The stacker of claim 17 further including an electromagnet selectively securing the hook in a locked position in which the hook secures the dolly in the dolly-receiving area.

19. A stacker comprising:
a base having a dolly-receiving area into which a dolly can be rolled;
a vertical structure supported on the base; and
a pair of arms movable vertically relative to the vertical structure and configured to engage containers supported on a dolly in the dolly-receiving area, wherein the pair of arms are configured to revolve about an axis generally parallel to the arms and spaced away from the arms.

20. The stacker of claim 19 further including an upper support above each of the pair of arms.

21. The stacker of claim 20 wherein the upper support is spaced above each of the pair of arms.

22. The stacker of claim 21 further including a front tip guard extending upward from each of the pair of arms and wherein each upper support is secured to one of the front tip guards.

23. The stacker of claim 19 further including side walls extending upward from each of the pair of arms.

24. The stacker of claim 23 wherein at least one of the side walls includes an upper portion angling outward as it extends upward.

25. A stacker comprising:
a base having a dolly-receiving area into which a dolly can be rolled;
a vertical structure supported on the base; and
a pair of arms movable vertically relative to the vertical structure and configured to engage containers supported on a dolly in the dolly-receiving area, wherein the pair of arms are part of a lifting unit, which is removable from the remainder of the stacker.

26. The stacker of claim 25 wherein the stacker includes a shuttle mounted to the vertical structure and movable vertically relative to the vertical structure, wherein the lifting unit is removably mounted to the shuttle.
